(19) United States
(12) Patent Application Publication
(10) Pub. No.: US 2023/0325246 A1
(43) Pub. Date: Oct. 12, 2023

(54) DYNAMIC HARDWARE PROFILE MODIFICATION

(71) Applicant: Intel Corporation, Santa Clara, CA (US)

(72) Inventors: Francesc Guim Bernat, Barcelona (ES); Karthik Kumar, Chandler, AZ (US); John J. Browne, Limerick (IE); Amruta Misra, Bangalore (IN); Chris M. MacNamara, Ballyclough (IE)

(73) Assignee: Intel Corporation, Santa Clara, CA (US)

(21) Appl. No.: 18/326,773

(22) Filed: May 31, 2023

(51) Int. Cl. G06F 9/50; H04L 12/14

(52) U.S. Cl. CPC G06F 9/5033; G06F 9/5044; H04L 12/1432

(57) ABSTRACT

A platform includes a plurality of hardware blocks to provide respective functionality for use in execution of an application. A subset of the plurality of hardware blocks are deactivated and unavailable for use in the execution of the application at the start of the execution of the application. A hardware profile modification block of the platform identifies receives telemetry data generated by a set of sensors and dynamically activates at least a particular one of the subset of hardware blocks based on the physical characteristics, where following activation of the particular hardware block, the execution of the application continues and uses the particular hardware block.

### FIELD

The present disclosure relates in general to the field of distributed computing systems, and more specifically, to computing devices in a distributed computing environment.

### BACKGROUND

A datacenter may include one or more platforms each comprising at least one processor and associated memory modules. Each platform of the datacenter may facilitate the performance of any suitable number of processes associated with various applications running on the platform. These processes may be performed by the processors and other associated logic of the platforms. External conditions within the environment in which a datacenter or other computing system is deployed may impact the performance of the system.

### BRIEF DESCRIPTION OF THE DRAWINGS

FIG. 1 is a simplified block diagram illustrating an overview of an edge cloud configuration for edge computing.

FIG. 2 is a simplified block diagram illustrating operational layers among endpoints, an Edge cloud, and cloud computing environments.

FIG. 3 is a simplified block diagram illustrating an example approach for networking and services in an edge computing system.

FIGS. 4A-4B are simplified flow diagrams illustrating example components within an example platform device in an edge computing system.

FIG. 5 is a simplified block diagram illustrating an example implementation of an edge computing deployment.

FIG. 6 is a simplified block diagram illustrating an example data flow.

FIG. 7 is a simplified block diagram illustrating an example platform device.

FIG. 8 is a simplified block diagram illustrating an example system including platform devices in an edge deployment.

FIG. 9 is a simplified flow diagram illustrating an example technique for dynamically modifying a hardware profile of a platform device.

FIG. 10 illustrates a block diagram of components of an example deployment.

Like reference numbers and designations in the various drawings indicate like elements.

### DETAILED DESCRIPTION

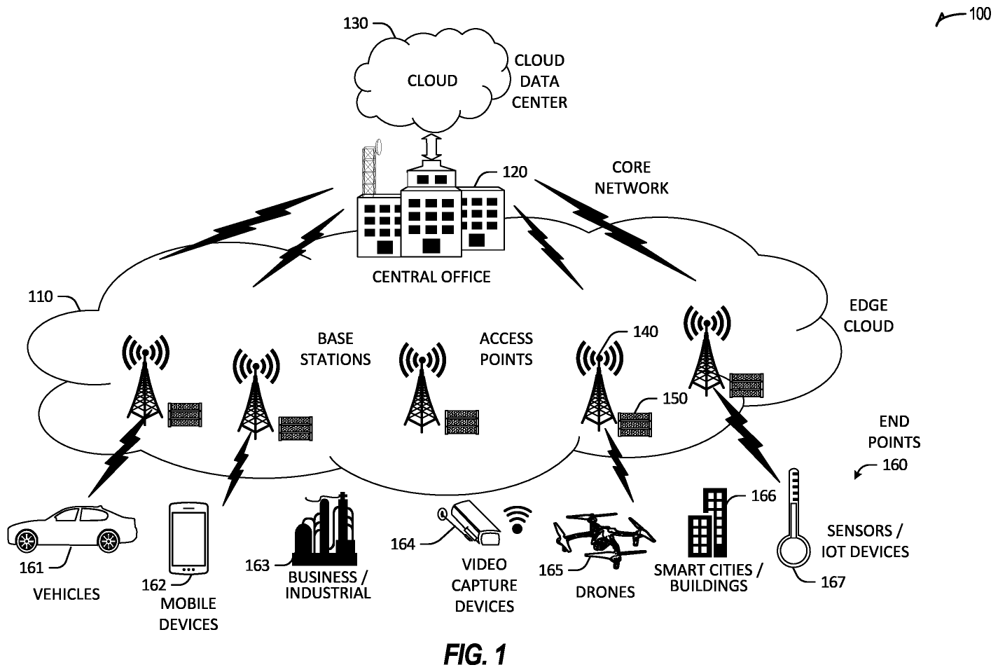

FIG. 1 is a block diagram 100 showing an overview of a configuration for Edge computing, which includes a layer of processing referred to in many of the following examples as an “Edge cloud”. As shown, the Edge cloud 110 is co-located at an Edge location, such as an access point or base station 140, a local processing hub 150, or a central office 120, and thus may include multiple entities, devices, and equipment instances. The Edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the Edge cloud 110 are critical to providing ultra-low latency response times for services and functions used by the endpoint data sources 160 as well as reduce network backhaul traffic from the Edge cloud 110 toward cloud data center 130 thus improving energy consumption and overall network usages among other benefits.

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate, or, bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge”, “close Edge”, “local Edge”, “middle Edge”, or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

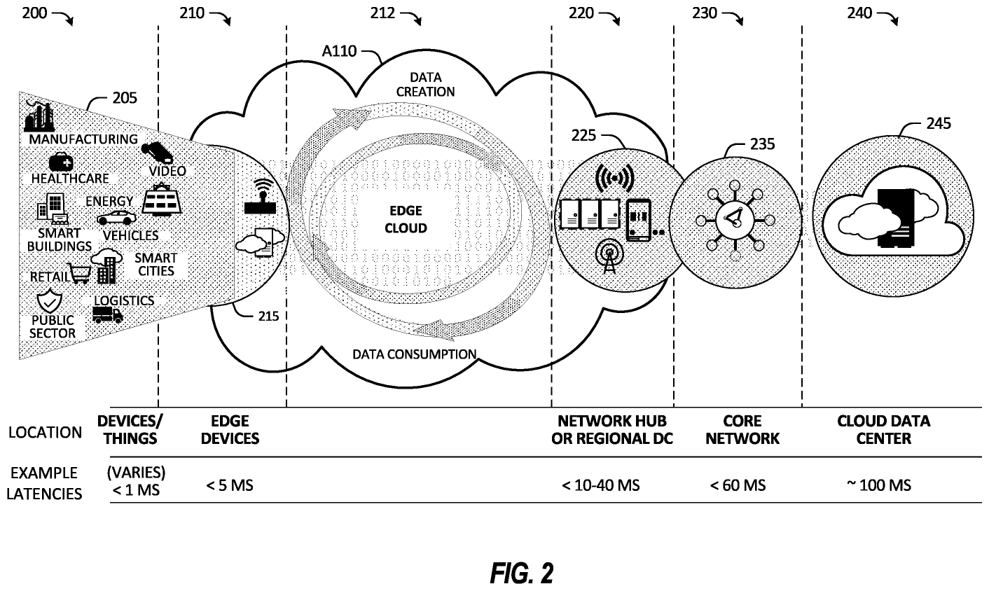

FIG. 2 illustrates operational layers among endpoints, an Edge cloud, and cloud computing environments. Specifically, FIG. 2 depicts examples of computational use cases 205, utilizing the Edge cloud 110 among multiple illustrative layers of network computing. The layers begin at an endpoint (devices and things) layer 200, which accesses the Edge cloud 110 to conduct data creation, analysis, and data consumption activities. The Edge cloud 110 may span multiple network layers, such as an Edge devices layer 210 having gateways, on-premise servers, or network equipment (nodes 215) located in physically proximate Edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the Edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the Edge devices layer 210, to even between 10 to 40 ms when communicating with nodes at the network access layer 220. Beyond the Edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close Edge”, “local Edge”, “near Edge”, “middle Edge”, or “far Edge” layers, relative to a network source and destination. For instance, from the perspective of the core network data center 235 or a cloud data center 245, a central office or content data network may be considered as being located within a “near Edge” layer (“near” to the cloud, having high latency values when communicating with the devices and endpoints of the use cases 205), whereas an access point, base station, on-premise server, or network gateway may be considered as located within a “far Edge” layer (“far” from the cloud, having low latency values when communicating with the devices and endpoints of the use cases 205). It will be understood that other categorizations of a particular network layer as constituting a “close”, “local”, “near”, “middle”, or “far” Edge may be based on latency, distance, number of network hops, or other measurable characteristics, as measured from a source in any of the network layers 200-240.

The various use cases 205 may access resources under usage pressure from incoming streams, due to multiple services utilizing the Edge cloud. To achieve results with low latency, the services executed within the Edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, Edge computing within the Edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because Edge locations may be unmanned and may even need permissioned access (e.g., when housed in a third-party location). Such issues are magnified in the Edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud 110 (network layers 200-240), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco”, or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 110.

As such, the Edge cloud 110 is formed from network components and functional features operated by and within Edge gateway nodes, Edge aggregation nodes, or other Edge compute nodes among network layers 210-230. The Edge cloud 110 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud 110 may be envisioned as an “Edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

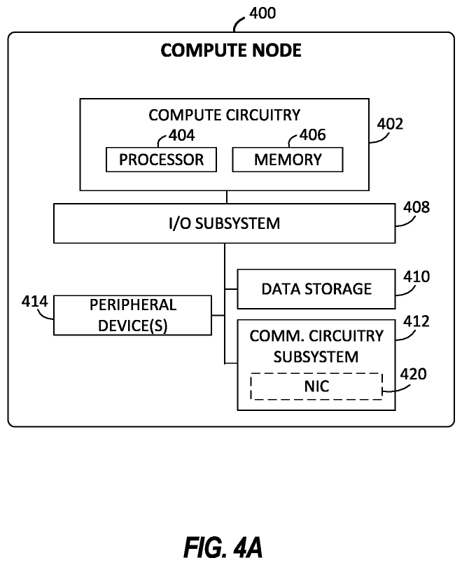

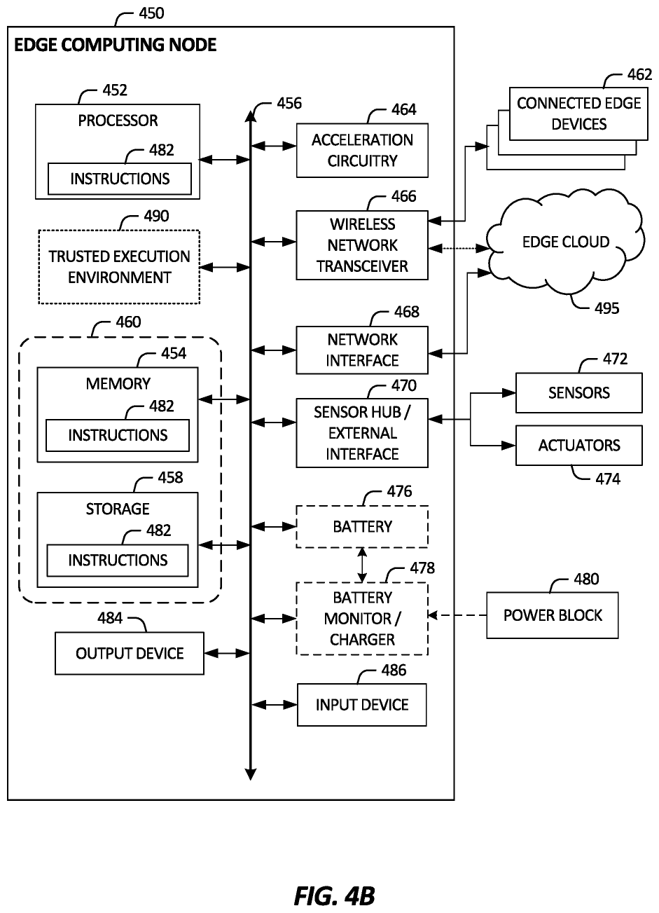

The network components of the Edge cloud 110 may be servers, multi-tenant servers, appliance computing devices, and/or any other type of computing devices. For example, the Edge cloud 110 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, atmospheric pressure, humidity, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input devices such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with the examples of FIGS. 4A-4B below, among other examples. The Edge cloud 110 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

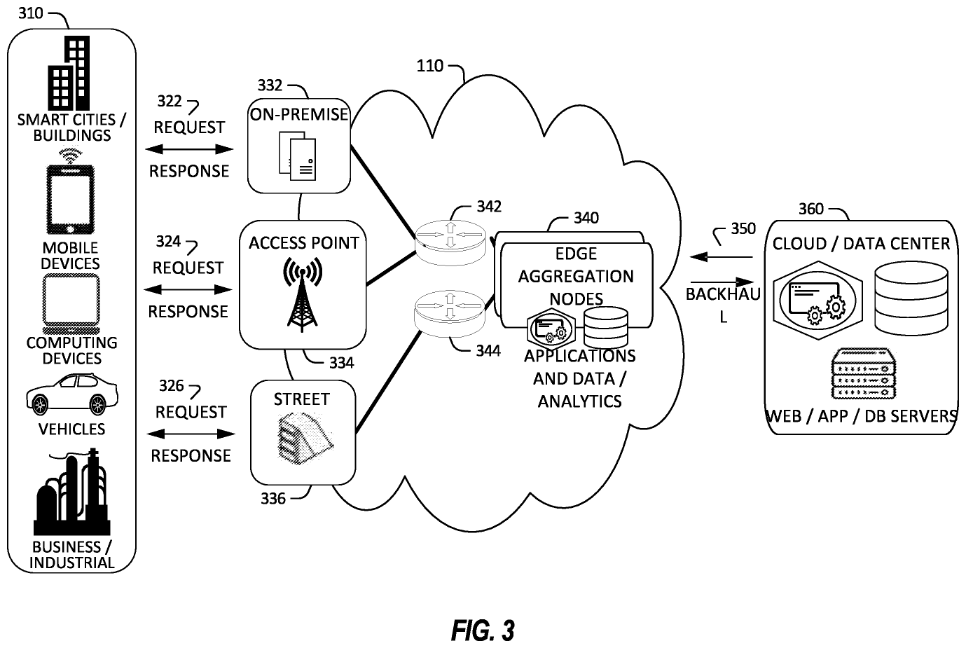

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the Edge cloud 110 to aggregate traffic and requests. Thus, within the Edge cloud 110, the TSP may deploy various compute and storage resources, such as at Edge aggregation nodes 340, to provide requested content. The Edge aggregation nodes 340 and other systems of the Edge cloud 110 are connected to a cloud or data center 360, which uses a backhaul network 350 to fulfill higher-latency requests from a cloud/data center for websites, applications, database servers, etc. Additional or consolidated instances of the Edge aggregation nodes 340 and the aggregation points 342, 344, including those deployed on a single server framework, may also be present within the Edge cloud 110 or other areas of the TSP infrastructure.

In further examples, any of the compute nodes or devices discussed with reference to the present Edge computing systems and environment may be fulfilled based on the components depicted in FIGS. 4A and 4B. Respective Edge compute nodes may be embodied as a type of device, appliance, computer, or other “thing” capable of communicating with other Edge, networking, or endpoint components. For example, an Edge compute device may be embodied as a personal computer, server, smartphone, a mobile compute device, a smart appliance, an in-vehicle compute system (e.g., a navigation system), a scalable I/O virtualization (S-IOV) device, a self-contained device having an outer case, shell, etc., or other device or system capable of performing the described functions.

In the simplified example depicted in FIG. 4A, an Edge compute node 400 includes a compute engine (also referred to herein as “compute circuitry”) 402, an input/output (I/O) subsystem (also referred to herein as “I/O circuitry”) 408, data storage (also referred to herein as “data storage circuitry”) 410, a communication circuitry subsystem 412, and, optionally, one or more peripheral devices (also referred to herein as “peripheral device circuitry”) 414. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 400 may be embodied as any type of engine, device, or collection of devices capable of performing various compute functions. In some examples, the compute node 400 may be embodied as a single device such as an integrated circuit, an embedded system, a field-programmable gate array (FPGA), a system-on-a-chip (SOC), or other integrated system or device. In the illustrative example, the compute node 400 includes or is embodied as a processor (also referred to herein as “processor circuitry”) 404 and a memory (also referred to herein as “memory circuitry”) 406. The processor 404 may be embodied as any type of processor(s) capable of performing the functions described herein (e.g., executing an application). For example, the processor 404 may be embodied as a multi-core processor(s), a microcontroller, a processing unit, a specialized or special purpose processing unit, or other processor or processing/controlling circuit.

In some examples, the processor 404 may be embodied as, include, or be coupled to an FPGA, an application specific integrated circuit (ASIC), reconfigurable hardware or hardware circuitry, or other specialized hardware to facilitate performance of the functions described herein. The processor 404 may include components and logic, which may be reconfigured or reprogrammed (e.g., a reprogrammable FPGA). Also in some examples, the processor 404 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, storage disks, or AI hardware (e.g., GPUs, programmed FPGAs, or ASICs tailored to implement an AI model such as a neural network). Such an xPU may be designed to receive, retrieve, and/or otherwise obtain programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that an xPU, an SOC, a CPU, and other variations of the processor 404 may work in coordination with each other to execute many types of operations and instructions within and on behalf of the compute node 400.

The memory 406 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device (e.g., memory circuitry) is any number of block addressable memory devices, such as those based on NAND or NOR technologies (for example, Single-Level Cell (“SLC”), Multi-Level Cell (“MLC”), Quad-Level Cell (“QLC”), Tri-Level Cell (“TLC”), or some other NAND). In some examples, the memory device(s) includes a byte-addressable write-in-place three dimensional crosspoint memory device, or other byte addressable write-in-place non-volatile memory (NVM) devices, such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric transistor random access memory (FeTRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, a combination of any of the above, or other suitable memory. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may include a transistor-less stackable cross point architecture in which memory cells sit at the intersection of word lines and bit lines and are individually addressable and in which bit storage is based on a change in bulk resistance. In some examples, all or a portion of the memory 406 may be integrated into the processor 404. The memory 406 may store various software and data used during operation such as one or more applications, data operated on by the application(s), libraries, and drivers.

In some examples, resistor-based and/or transistor-less memory architectures include nanometer scale phase-change memory (PCM) devices in which a volume of phase-change material resides between at least two electrodes. Portions of the example phase-change material exhibit varying degrees of crystalline phases and amorphous phases, in which varying degrees of resistance between the at least two electrodes can be measured. In some examples, the phase-change material is a chalcogenide-based glass material. Such resistive memory devices are sometimes referred to as memristive devices that remember the history of the current that previously flowed through them. Stored data is retrieved from example PCM devices by measuring the electrical resistance, in which the crystalline phases exhibit a relatively lower resistance value(s) (e.g., logical “0”) when compared to the amorphous phases having a relatively higher resistance value(s) (e.g., logical “1”).

Example PCM devices store data for long periods of time (e.g., approximately 10 years at room temperature). Write operations to example PCM devices (e.g., set to logical “0”, set to logical “1”, set to an intermediary resistance value) are accomplished by applying one or more current pulses to the at least two electrodes, in which the pulses have a particular current magnitude and duration. For instance, a long low current pulse (SET) applied to the at least two electrodes causes the example PCM device to reside in a low-resistance crystalline state, while a comparatively short high current pulse (RESET) applied to the at least two electrodes causes the example PCM device to reside in a high-resistance amorphous state.

In some examples, implementation of PCM devices facilitates non-von Neumann computing architectures that enable in-memory computing capabilities. Generally speaking, traditional computing architectures include a central processing unit (CPU) communicatively connected to one or more memory devices via a bus. As such, a finite amount of energy and time is consumed to transfer data between the CPU and memory, which is a known bottleneck of von Neumann computing architectures. However, PCM devices minimize and, in some cases, eliminate data transfers between the CPU and memory by performing some computing operations in-memory. Stated differently, PCM devices both store information and execute computational tasks. Such non-von Neumann computing architectures may implement vectors having a relatively high dimensionality to facilitate hyperdimensional computing, such as vectors having 10,000 bits. Relatively large bit width vectors enable computing paradigms modeled after the human brain, which also processes information analogous to wide bit vectors.

The compute circuitry 402 is communicatively coupled to other components of the compute node 400 via the I/O subsystem 408, which may be embodied as circuitry and/or components to facilitate input/output operations with the compute circuitry 402 (e.g., with the processor 404 and/or the main memory 406) and other components of the compute circuitry 402. For example, the I/O subsystem 408 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 408 may form a portion of a system-on-a-chip (SoC) and be incorporated, along with one or more of the processor 404, the memory 406, and other components of the compute circuitry 402, into the compute circuitry 402.

The one or more illustrative data storage devices/disks 410 may be embodied as one or more of any type(s) of physical device(s) configured for short-term or long-term storage of data such as, for example, memory devices, memory, circuitry, memory cards, flash memory, hard disk drives (HDDs), solid-state drives (SSDs), and/or other data storage devices/disks. Individual data storage devices/disks 410 may include a system partition that stores data and firmware code for the data storage device/disk 410. Individual data storage devices/disks 410 may also include one or more operating system partitions that store data files and executables for operating systems depending on, for example, the type of compute node 400.

The communication circuitry 412 may be embodied as any communication circuit, device, or collection thereof, capable of enabling communications over a network between the compute circuitry 402 and another compute device (e.g., an Edge gateway of an implementing Edge computing system). The communication circuitry 412 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 412 includes a network interface controller (NIC) 420, which may also be referred to as a host fabric interface (HFI). The NIC 420 may be embodied as one or more add-in-boards, daughter cards, network interface cards, controller chips, chipsets, or other devices that may be used by the compute node 400 to connect with another compute device (e.g., an Edge gateway node). In some examples, the NIC 420 may be embodied as part of a system-on-a-chip (SoC) that includes one or more processors, or included on a multichip package that also contains one or more processors. In some examples, the NIC 420 may include a local processor (not shown) and/or a local memory (not shown) that are both local to the NIC 420. In such examples, the local processor of the NIC 420 may be capable of performing one or more of the functions of the compute circuitry 402 described herein. Additionally, or alternatively, in such examples, the local memory of the NIC 420 may be integrated into one or more components of the client compute node at the board level, socket level, chip level, and/or other levels.

Additionally, in some examples, a respective compute node 400 may include one or more peripheral devices 414. Such peripheral devices 414 may include any type of peripheral device found in a compute device or server such as audio input devices, a display, other input/output devices, interface devices, and/or other peripheral devices, depending on the particular type of the compute node 400. In further examples, the compute node 400 may be embodied by a respective Edge compute node (whether a client, gateway, or aggregation node) in an Edge computing system or like forms of appliances, computers, subsystems, circuitry, or other components.

In a more detailed example, FIG. 4B illustrates a block diagram of an example of components that may be present in an Edge computing node 450 for implementing the techniques (e.g., operations, processes, methods, and methodologies) described herein. This Edge computing node 450 provides a closer view of the respective components of node 400 when implemented as or as part of a computing device (e.g., as a mobile device, a base station, server, gateway, etc.). The Edge computing node 450 may include any combination of the hardware or logical components referenced herein, and it may include or couple with any device usable with an Edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the Edge computing node 450, or as components otherwise incorporated within a chassis of a larger system.

The Edge computing device 450 may include processing circuitry in the form of a processor 452, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 452 may be a part of a system on a chip (SoC) in which the processor 452 and other components are formed into a single integrated circuit, or a single package, such as the Edison™ or Galileo™ SoC boards from Intel Corporation, Santa Clara, California. As an example, the processor 452 may include an Intel® Architecture Core™ based CPU processor, such as a Quark™, an Atom™ an i3, an i5, an i7, an i9, or an MCU-class processor, or another such processor available from Intel®. However, any number other processors may be used, such as available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 452 and accompanying circuitry may be provided in a single socket form factor, multiple socket form factor, or a variety of other formats, including in limited hardware configurations or configurations that include fewer than all elements shown in FIG. 4B.

The processor 452 may communicate with a system memory 454 over an interconnect 456 (e.g., a bus). Any number of memory devices may be used to provide for a given amount of system memory. As examples, the memory 454 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 458 may also couple to the processor 452 via the interconnect 456. In an example, the storage 458 may be implemented via a solid-state disk drive (SSDD). Other devices that may be used for the storage 458 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 458 may be on-die memory or registers associated with the processor 452. However, in some examples, the storage 458 may be implemented using a micro hard disk drive (HDD). Further, any number of new technologies may be used for the storage 458 in addition to, or instead of, the technologies described, such resistance change memories, phase change memories, holographic memories, or chemical memories, among others.

The components may communicate over the interconnect 456. The interconnect 456 may include any number of technologies, including industry standard architecture (ISA), extended ISA (EISA), peripheral component interconnect (PCI), peripheral component interconnect extended (PCIx), PCI express (PCIe), or any number of other technologies. The interconnect 456 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 456 may couple the processor 452 to a transceiver 466, for communications with the connected Edge devices 462. The transceiver 466 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected Edge devices 462. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 466 (or multiple transceivers) may communicate using multiple standards or radios for communications at a different range. For example, the Edge computing node 450 may communicate with close devices, e.g., within about 10 meters, using a local transceiver based on Bluetooth Low Energy (BLE), or another low power radio, to save power. More distant connected Edge devices 462, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 466 (e.g., a radio transceiver) may be included to communicate with devices or services in a cloud (e.g., an Edge cloud 495) via local or wide area network protocols. The wireless network transceiver 466 may be a low-power wide-area (LPWA) transceiver that follows the IEEE 802.15.4, or IEEE 802.15.4g standards, among others. The Edge computing node 450 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 466, as described herein. For example, the transceiver 466 may include a cellular transceiver that uses spread spectrum (SPA/SAS) communications for implementing high-speed communications. Further, any number of other protocols may be used, such as Wi-Fi® networks for medium speed communications and provision of network communications. The transceiver 466 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 468 may be included to provide a wired communication to nodes of the Edge cloud 495 or to other devices, such as the connected Edge devices 462 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 468 may be included to enable connecting to a second network, for example, a first NIC 468 providing communications to the cloud over Ethernet, and a second NIC 468 providing communications to other devices over another type of network.

Given the variety of types of applicable communications from the device to another component or network, applicable communications circuitry used by the device may include or be embodied by any one or more of components 464, 466, 468, or 470. Accordingly, in various examples, applicable means for communicating (e.g., receiving, transmitting, etc.) may be embodied by such communications circuitry.

The Edge computing node 450 may include or be coupled to acceleration circuitry 464, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific Edge computing tasks for service management and service operations discussed elsewhere in this document.

The interconnect 456 may couple the processor 452 to a sensor hub or external interface 470 that is used to connect additional devices or subsystems. The devices may include sensors 472, such as accelerometers, level sensors, flow sensors, optical light sensors, camera sensors, temperature sensors, global navigation system (e.g., GPS) sensors, pressure sensors, barometric pressure sensors, and the like. The hub or interface 470 further may be used to connect the Edge computing node 450 to actuators 474, such as power switches, valve actuators, an audible sound generator, a visual warning device, and the like.

In some optional examples, various input/output (I/O) devices may be present within or connected to, the Edge computing node 450. For example, a display or other output device 484 may be included to show information, such as sensor readings or actuator position. An input device 486, such as a touch screen or keypad may be included to accept input. An output device 484 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the Edge computing node 450. A display or console hardware, in the context of the present system, may be used to provide output and receive input of an Edge computing system; to manage components or services of an Edge computing system; identify a state of an Edge computing component or service; or to conduct any other number of management or administration functions or service use cases.

A battery 476 may power the Edge computing node 450, although, in examples in which the Edge computing node 450 is mounted in a fixed location, it may have a power supply coupled to an electrical grid, or the battery may be used as a backup or for temporary capabilities. The battery 476 may be a lithium ion battery, or a metal-air battery, such as a zinc-air battery, an aluminum-air battery, a lithium-air battery, and the like.

A battery monitor/charger 478 may be included in the Edge computing node 450 to track the state of charge (SoCh) of the battery 476, if included. The battery monitor/charger 478 may be used to monitor other parameters of the battery 476 to provide failure predictions, such as the state of health (SoH) and the state of function (SoF) of the battery 476. The battery monitor/charger 478 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 478 may communicate the information on the battery 476 to the processor 452 over the interconnect 456. The battery monitor/charger 478 may also include an analog-to-digital (ADC) converter that enables the processor 452 to directly monitor the voltage of the battery 476 or the current flow from the battery 476. The battery parameters may be used to determine actions that the Edge computing node 450 may perform, such as transmission frequency, mesh network operation, sensing frequency, and the like.

A power block 480, or other power supply coupled to a grid, may be coupled with the battery monitor/charger 478 to charge the battery 476. In some examples, the power block 480 may be replaced with a wireless power receiver to obtain the power wirelessly, for example, through a loop antenna in the Edge computing node 450. A wireless battery charging circuit, such as an LTC4020 chip from Linear Technologies of Milpitas, California, among others, may be included in the battery monitor/charger 478. The specific charging circuits may be selected based on the size of the battery 476, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 458 may include instructions 482 in the form of software, firmware, or hardware commands to implement the techniques described herein. Although such instructions 482 are shown as code blocks included in the memory 454 and the storage 458, it may be understood that any of the code blocks may be replaced with hardwired circuits, for example, built into an application specific integrated circuit (ASIC).

In an example, the instructions 482 provided via the memory 454, the storage 458, or the processor 452 may be embodied as a non-transitory, machine-readable medium 460 including code to direct the processor 452 to perform electronic operations in the Edge computing node 450. The processor 452 may access the non-transitory, machine-readable medium 460 over the interconnect 456. For instance, the non-transitory, machine-readable medium 460 may be embodied by devices described for the storage 458 or may include specific storage units such as storage devices and/or storage disks that include optical disks (e.g., digital versatile disk (DVD), compact disk (CD), CD-ROM, Blu-ray disk), flash drives, floppy disks, hard drives (e.g., SSDs), or any number of other hardware devices in which information is stored for any duration (e.g., for extended time periods, permanently, for brief instances, for temporarily buffering, and/or caching). The non-transitory, machine-readable medium 460 may include instructions to direct the processor 452 to perform a specific sequence or flow of actions, for example, as described with respect to the flowchart(s) and block diagram(s) of operations and functionality depicted above. As used herein, the terms “machine-readable medium” and “computer-readable medium” are interchangeable. As used herein, the term “non-transitory computer-readable medium” is expressly defined to include any type of computer readable storage device and/or storage disk and to exclude propagating signals and to exclude transmission media.

Also in a specific example, the instructions 482 on the processor 452 (separately, or in combination with the instructions 482 of the machine readable medium 460) may configure execution or operation of a trusted execution environment (TEE) 490. In an example, the TEE 490 operates as a protected area accessible to the processor 452 for secure execution of instructions and secure access to data. Various implementations of the TEE 490, and an accompanying secure area in the processor 452 or the memory 454 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 450 through the TEE 490 and the processor 452.

While the illustrated examples of FIG. 4A and FIG. 4B include example components for a compute node and a computing device, respectively, examples disclosed herein are not limited thereto. As used herein, a “computer” may include some or all of the example components of FIGS. 4A and/or 4B in different types of computing environments. Example computing environments include Edge computing devices (e.g., Edge computers) in a distributed networking arrangement such that particular ones of participating Edge computing devices are heterogenous or homogeneous devices. As used herein, a “computer” may include a personal computer, a server, user equipment, an accelerator, etc., including any combinations thereof. In some examples, distributed networking and/or distributed computing includes any number of such Edge computing devices as illustrated in FIGS. 4A and/or 4B, each of which may include different sub-components, different memory capacities, I/O capabilities, etc. For example, because some implementations of distributed networking and/or distributed computing are associated with particular desired functionality, examples disclosed herein include different combinations of components illustrated in FIGS. 4A and/or 4B to satisfy functional objectives of distributed computing tasks. In some examples, the term “compute node” or “computer” only includes the example processor 404, memory 406 and I/O subsystem 408 of FIG. 4A. In some examples, one or more objective functions of a distributed computing task(s) rely on one or more alternate devices/structure located in different parts of an Edge networking environment, such as devices to accommodate data storage (e.g., the example data storage 410), input/output capabilities (e.g., the example peripheral device(s) 414), and/or network communication capabilities (e.g., the example NIC 420).

In some examples, computers operating in a distributed computing and/or distributed networking environment (e.g., an Edge network) are structured to accommodate particular objective functionality in a manner that reduces computational waste. For instance, because a computer includes a subset of the components disclosed in FIGS. 4A and 4B, such computers satisfy execution of distributed computing objective functions without including computing structure that would otherwise be unused and/or underutilized. As such, the term “computer” as used herein includes any combination of structure of FIGS. 4A and/or 4B that is capable of satisfying and/or otherwise executing objective functions of distributed computing tasks. In some examples, computers are structured in a manner commensurate to corresponding distributed computing objective functions in a manner that downscales or upscales in connection with dynamic demand. In some examples, different computers are invoked and/or otherwise instantiated in view of their ability to process one or more tasks of the distributed computing request(s), such that any computer capable of satisfying the tasks proceed with such computing activity.

In the illustrated examples of FIGS. 4A and 4B, computing devices include operating systems. As used herein, an “operating system” is software to control example computing devices, such as the example Edge compute node 400 of FIG. 4A and/or the example Edge compute node 450 of FIG. 4B. Example operating systems include, but are not limited to consumer-based operating systems (e.g., Microsoft® Windows® 10, Google® Android® OS, Apple® Mac® OS, etc.). Example operating systems also include, but are not limited to industry-focused operating systems, such as real-time operating systems, hypervisors, etc. An example operating system on a first Edge compute node may be the same or different than an example operating system on a second Edge compute node. In some examples, the operating system invokes alternate software to facilitate one or more functions and/or operations that are not native to the operating system, such as particular communication protocols and/or interpreters. In some examples, the operating system instantiates various functionalities that are not native to the operating system. In some examples, operating systems include varying degrees of complexity and/or capabilities. For instance, a first operating system corresponding to a first Edge compute node includes a real-time operating system having particular performance expectations of responsivity to dynamic input conditions, and a second operating system corresponding to a second Edge compute node includes graphical user interface capabilities to facilitate end-user I/O.

Unlike traditional data center deployments, even for a single use case, edge computing devices, such as edge servers, may be physically deployed in a variety of different locations and environments with varying characteristics. For instance, a particular edge computing system may be deployed from street cabinets to mountains to roadways to remote deserts to underwater deployments, etc. In some applications, edge computing devices may be mobile in that the same edge device is moved between different locations over time. For instance, example edge server units may be moved between locations depending on needs and usages. As an example, a big event may necessitate presence of a large number of edge servers within certain proximity to handle data traffic or processing in connection with the event and a number of edge servers may be temporarily deployed to the location of the event. Indeed, a similar event in a different location (e.g., a sporting event, concert, festival, conference, etc.) may involve moving at least a subset of this number of edge servers to this different location after being used in the first event, among a variety of other examples. The different locations may involve different issues, for instance, the same edge server may be deployed in a location with mild weather one weekend and then redeployed to a hot weather location, in which immersion cooling or other cooling solution would be needed to maintain the equipment, among other examples.

Considering the above, the nature of some edge computing device deployments may mean that there is no one-size-fits-all set of conditions or requirements for such devices. Indeed, many criteria are to be factored and decided a priori in edge deployments. Some examples of variations include temperature management, power management, security, reliability, temporal utilization, variable hardware needs, variable bandwidth/capacity demands, and so on. For instance, from a cooling and power management perspective, a machine, while located in location X, may be subject to more ambient temperature variation than location Y. Similarly, a machine in the summer season is more likely to require aggressive cooling compared to winter temperatures. And severe cold temperatures may pose additional challenges, such as diminished battery power, among other examples. Accordingly, different platforms with different features (e.g., less thermals optimized) may be desired on a variable basis for a particular edge deployment. Some deployments may fall within easily manageable temperature ranges, while other applications call for “extended” temperature range compatibilities (e.g., in certain extreme weather geographical settings or industrial settings, etc.).

In other examples, varying services levels or reliability, accessibility, and serviceability (RAS) settings and features may be deployed in an edge computing deployment. For instance, higher temperatures may generally imply greater error rates. To combat this and other applications where error rates may be more likely, RAS features found in higher end edge computing systems may be deployed. As another example, deployments at high altitudes, such as elevation deployed base stations, results in greater error probability for memory modules caused by alpha particles. As still another example, geographic regions more prone to natural disasters or power outages (e.g., in a storm or earthquake region) may be more prone to power interruptions, brown-outs, and/or physical shock to components, and edge devices with components or features capable of mitigating such effects may be advantageous in such regions.

Further, some applications may advantageously make use of edge computing systems with specialized or enhanced processing, memory management, interconnect, or hardware acceleration features. As an example, some workloads, which an edge deployment may be called upon to handle may vary in complexity. For instance, SIMD units (e.g., AVX*units) may be powerfully deployed in applications where vector processing is utilized, while in other tasks (e.g., even within the same deployment) the use of such hardware would add unjustifiable power overhead that could be better used providing higher core frequencies, among other example features and tradeoffs. Similarly, utilization may vary, both in terms of the networking/communication bandwidth employed, interconnect bandwidth, processor utilization, memory usage, etc. For instance, CPU utilization may vary heavily by time of day or month or year, in response to the presence of crowds or events, among other examples.

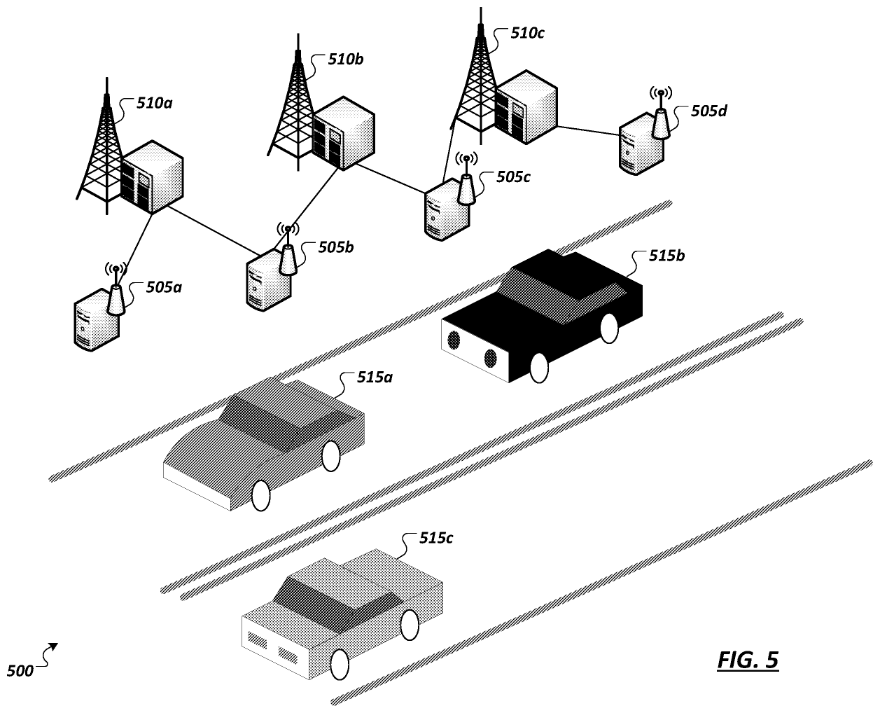

Turning to FIG. 5, a diagram 500 is shown illustrating an example implementation of an edge computing deployment at scale. In the example of FIG. 5, the edge deployment may be in association with a roadside data network, where a number of roadside edge computing systems (e.g., 505a-d) and base station systems (e.g., 510a-c) are deployed, which may be accessed by on-board computing systems of vehicles (e.g., 515a-c) as they pass through corresponding coverage zones. In such an environment, several of the above mentioned variables and diverse conditions will manifest. For instance, weather conditions may vary, the amount of traffic and connections with on-board vehicle systems may vary, events may take place on the roadways (e.g., accidents or emergency events) requiring enhanced processing or additional workloads, among other examples. Other systems (e.g., beside edge deployments) may include computing devices, which may include functionality such as discussed herein, such as a data center, content delivery network, or micro-data center deployment, among other examples, with one or more devices supported dynamic hardware profile reconfiguration based on detected physical environmental conditions, among other examples.

Traditionally, for a system designer managing the edge deployment, hardware, architectures, and features may be selected based on provisioning for worst case requirements or the most demanding moments, which may result in more feature-rich (and expensive) system elements being selected for deployment, even when the features are used relatively rarely. In other cases, such feature-heavy system components and edge computing systems may be cost prohibitive and ultimately limit the success and scale of the associated edge deployment, among other example issues.

Traditional systems are static in their feature sets and hardware capabilities—either they have the requisite hardware and have a requisite feature available or they do not. For instance, traditional systems do not account for and sense ambient context such as location, time of day, and other environment based telemetry in order to determine an appropriate device for a given use case. In some cases, designers may iterate through multiple versions of an edge deployment (e.g., trading out various edge system devices or components) to figure out the performance achievable for the use case based on feedback obtained through such iterations. In some cases, this can be enhanced with a priori user feedback or user specified context for an application. This can also depend on the deployment model, for example, if deployment model is a FlexRAN node one can use a 5G instruction set architecture (ISA), among other examples.

If it were desired to selectively enable/disable certain hardware or related functionality within a traditional edge computing device, such additions or modifications could be completely manually (e.g., by adding or removing an associated add-in card), but such changes are costly. While some devices may allow fuses or patches to be applied to change some aspects like cores or accelerator enablement within the device, currently, such changes are also completed manually, which is not scalable for vast deployments. Further, some systems do not provide a feedback mechanism to determine a desirable set of deployment component knobs for reliability and tracking performance of related service level agreement (SLA) or quality of service (QoS) policy. Further, some traditional systems do not provide mechanisms for predicting expected residency based on historical context, among other issues. Accordingly, modern system managers often resort to buying the most expensive component available to ensure even their edge conditions will be met, but such practices and expenses may ultimately limit industry adoption and slow momentum of development of such technologies, among other example issues.

In an improved system, computing devices and systems may be provided with logic, implemented in hardware and/or software, to adaptively determine changes that might be made within an edge deployment, and even within a single device or node within the deployment, in order to meet a given performance or reliability level (e.g., as defined within a service level agreement (SLA), in spite of variabilities within the deployment environment. For instance, an improved system may make hardware-level changes on the fly, within the deployment, based on real, expected, or predicted residency within a current context or set of conditions (e.g., determine that a current low temperature range is likely to persist based on the observed time of year verses a temporary cold shift, etc.). Further, an improved system may include hardware-level logic to securely meter and log decisions made that would impact the adaptive activation/deactivation of certain components and related functionality, but also the deactivations and reactivations themselves. Such changes to the edge components may also be captured and provided as feedback to sensing intelligence along with tracking of the predetermined performance or reliability policies in order to continuously improve the adaptive selection of the appropriate hardware to activate within the edge deployment. Accordingly, system architectures may be enhanced to adapt the active or available hardware depending on the current or predicted contextual situation of the platform and expected load within the edge deployment.

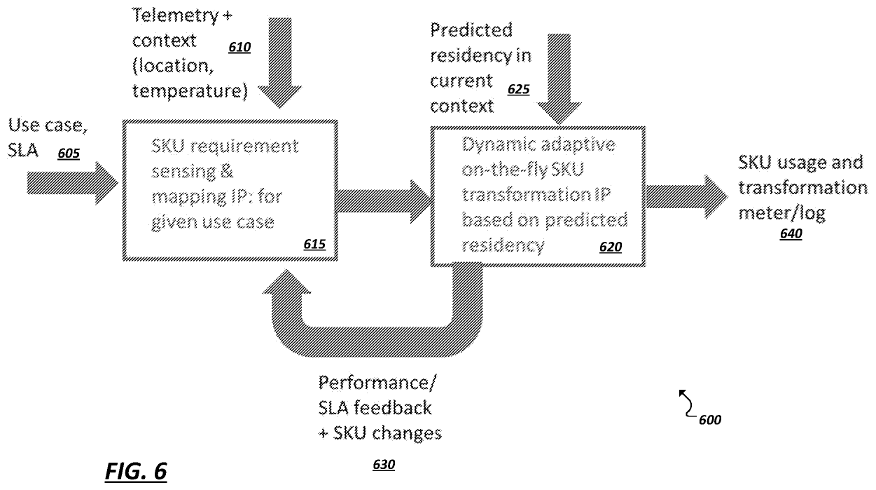

FIG. 6 is a simplified block diagram 600 illustrating data flows within an example dynamic edge system. To determine the context and demands upon a particular edge deployment and/or those of the individual devices making up the deployment, an application or use case may be identified (at 605) together with any policies, service level agreements, or quality of service guarantees, which may apply to the application. The use case may also identify the anticipated workload to be handled by the edge deployment. For instance, a video analytics application or use case that is to monitor video collected of subjects (e.g., persons, vehicles, events, etc.) within a physical space (e.g., a public street, a retail store, etc.) may utilize far less capacity of the edge device's resources (e.g., processing, memory, interconnect, etc.) if processing during a slow traffic period (with only a few subjects) as opposed to a high traffic period (with many more subjects, which the system's service level objective may require to be processed in parallel, among other examples. Additionally, telemetry and context information may be collected (e.g., using local or remote sensors) or detected (at 610) to identify conditions, which may impact the performance of hardware of the edge device. Together, from use case and context information, it may be determined (at 615) what combination of hardware components and functionality (or hardware profile or “SKU”) would be able to handle the use case in the measured context.

In some implementations, an edge platform device may be capable of dynamically activating or deactivating hardware components and hardware-implemented features of the device. Interfaces and circuitry may be provided through which software-based controllers may direct the secure activation of idle or locked hardware functionality of the device and likewise direct the deactivation of the same hardware blocks (e.g., to return them to a locked or inoperable state). For instance, the architecture of the platform device may enable the use of a secure kernel (e.g., OS kernel) to toggle various hardware blocks and subcircuits from activate to inactive/locked states and vice versa. As an example, a pre-authenticated software-based controller may be configured to securely activate/deactivate components of the platform, for instance, through messages in a defined license activation process. For instance, the message or command issued by the controller may include a capability-specific activation payload including authentication data. The host processor or other security hardened hardware may authenticate the message (e.g., using a key written to secure non-volatile memory of the platform (e.g., an Authentication Key Certificate)). The processor or corresponding socket may also selectively expose/hide which hardware blocks are active/inactive to the controller as well as which hardware blocks are capable of activation/deactivation, with such visibility limited to those controllers which are authenticated or pass an attestation process, among other example implementations. With a hardware block active, the functionality may be exposed for use by software executed at the platform.

In some implementations, an edge platform device may be capable of dynamically activating or deactivating hardware components and hardware-implemented features (e.g., using a software-based controller) depending on information collected from contextual sensors and the load being handled by the platform. Accordingly, one or more features may be activated/deactivated (at 620) to configure the hardware, even at the silicon level, to implement the identified hardware profile. Dynamic, on-the-fly reconfiguration of the edge hardware capabilities (at 620) may be further based on residency information (at 625), which may be provided by additional logic local to or remote from the device to identify a predicted duration of the use case's need for the new hardware configuration. Further, performance of the deployment (and the application being implemented using the edge deployment) may be monitored (at 630) to determine whether the dynamic hardware profile reconfiguration was successful in meeting the associated performance objectives. In some cases, this may serve as feedback to logic determining the proper hardware profile (at 615), allowing the hardware profile to be dynamically finetuned (e.g., to deactivate components, which may be underutilized or active additional components to improve performance, etc.).

In some implementations, such dynamically activated/deactivated functionality may enable a use-based billing model to be associated with such platforms, devices, and systems. For instance, rather than purchasing a device for its full price, a customer may agree to be billed in accordance with the features used or not used once the device has been deployed, and this use/non-use may be logged securely and reliably by the device to enable such a model. Accordingly, in some implementations, platform hardware for an edge deployment may be provided with metering and billing logic (e.g., implemented in the hardware of the platform) to log (at 640) when and why certain circuitry or functionality was activated and the measured benefit on the workload handled by the platform by virtue of such functionality being enabled. In this manner, fees associated with the temporary activation of an IP block or other logic on the platform may be assessed against the benefit realized from such activation. As an example, due to thermal constraints, it may be detected that a video analytic workload running on cores of an edge computing device is or will not be able to meet the associated service level requested or required of a deployment. In response to detecting or predicting such shortcomings in the combination of hardware or functionality activated at the platform, the platform may activate (e.g., at least temporarily to correspond with either or both the temperature conditions and/or workload) and a media processing (e.g., machine learning (ML)- or artificial intelligence (AI)-based) integrated hardware on the platform, and the platform may dynamically offload at least a portion of the workload from the CPU to this accelerator block, among other examples. The activation/deactivation of the hardware, the resulting hardware activation footprint in the platform, the reasons for the activation/deactivation, and the resulting performance impact may all be securely recorded and signed (to secure or attest to the trustworthiness of the measurement.

Changing the hardware profile of a system on the fly through activation or deactivation of various cores, IP blocks, accelerator circuitry, or other functional components may affect the application(s) running on or otherwise using the edge deployment. Accordingly, an application's deployment may also be configured to adapt responsively to the activation/deactivation of various hardware functionality on edge computing devices in the edge deployment. In some implementations, an orchestration system or engine (e.g., Kubernetes) may be included in an application deployment to assist in orchestrating deployment of an application with a cloud or edge computing environment. In some implementations, the orchestration system may also be enhanced to identify (e.g., through notification from an affected edge system) that a change to the hardware profile has occurred, which may be leveraged to migrate workloads to/from the activated/deactivated components of the deployment. In some implementations, features or components, which may be activated may be transparently exposed via microservices so that the user software application does not change. As one example, a service may include a microservice configured to provide an interface to the service that abstracts the hardware resources so that other services do not need to change when available hardware changes. For example, an encryption service that uses data encryption and compression hardware acceleration internally can scale resources (e.g., including balancing resources between hardware encryption and software encryption with Advanced Vector Extensions (AVX)), without services using the encryption service being aware of the change. As another example, a compression service may be provided that uses one or more hardware accelerators or software acceleration (e.g., with AVX-512) may scale and balance resources without other services being aware, among other examples.

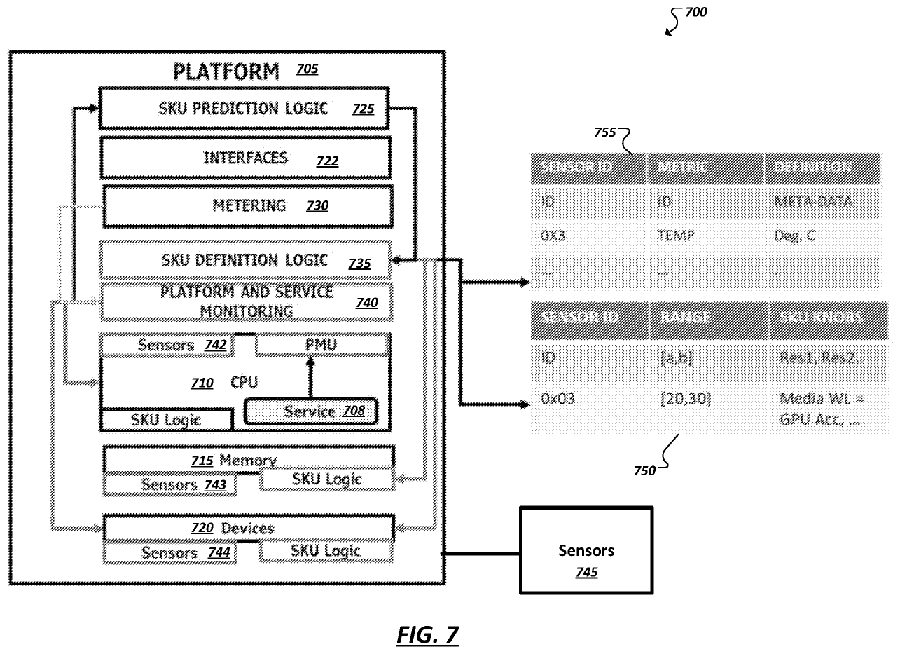

Turning to FIG. 7, a simplified block diagram 700 is shown illustrating an example edge platform device 705 equipped with circuitry to support dynamic changes to its hardware profile, allowing various hardware blocks and functionality within the platform to be activated or deactivated based on conditions detected at the platform device 705. In one example, the platform device 705 may include a central processing unit (CPU) or other host processing device (e.g., 710), which may include a set of processor cores. At least a portion of a service 708 or other workload may be executed or managed by the CPU 710. The CPU 710 may include functionality for activating and deactivating other components and notify the software stack of such hardware profile changes. Each individual processing core may be among the components, which may be selectively enabled or disabled at the platform device 705. As additional examples, the edge platform device 705 may include memory blocks (e.g., 715), and other devices (e.g., 720), such as IP blocks and other circuitry to implement interconnects, wireless communications, acceleration of various tasks and operations (e.g., video processing accelerators, machine learning or AI accelerators, graphics processing units, tensor and matrix arithmetic processors), among other examples. One or more interfaces and supporting protocol logic may also be provided (e.g., at 722) to facilitate busses and communication links between components of the platform device 705, as well as to facilitate connections to external devices and networks (e.g., in an edge deployment, to other devices in a distributed computing system, etc.).

In addition to components implementing hardware functionality which may be selectively and dynamically enabled/disabled for use by software in implementing an application or use case, an edge platform device 705 may additionally include blocks (e.g., implemented in local hardware and/or firmware) to allow such dynamic reconfigurations to be initiated at the platform level. In one example, a platform device 705 may additionally include hardware profile predictor block 725, metering block 730, hardware profile definition block 735, and platform and service monitoring block (e.g., 740), among other examples. These blocks (e.g., 725, 730, 735, 740, etc.) may be implemented as hardware circuitry within the platform device 705.

An improved device platform may have a number of hooks defined to allow the device to identify context of its deployment and dynamically re-define the resources (e.g., various IP blocks, accelerator blocks, processor cores, communication interfaces, etc. providing corresponding functionality) that are exposed in the host running on the platform. In some implementations, the platform device 705 may be additionally provided with or coupled to a set of ambient or contextual sensors 742-745 (e.g., location sensors, temperature sensors, humidity sensors, presence detect, power stability sensors, vibration sensors, etc.) to detect conditions and environment attributes, which may impact the performance of hardware within the platform device 705. In one example, data generated by the sensors 742-745 may be collected and monitored by the platform. Each of those sensors will be sampled by the platform monitoring unit 740. The platform may include registers or tables 755 (e.g., used by the platform monitoring unit 740) to identify the sensors and the type(s) of information, which may be provided through each. For instance, the platform device 705 may identify, for each sensor 742-745, its sensor identifier, the metric provided by the sensor, and the value of the metric, among other example information.

Rules or heuristics may be defined based on the context information that may be obtained from the set of sensors 742-745 monitoring conditions of the edge platform device 705. For instance, a register, table, or other structure 750 may be defined to indicate contexts (e.g., as defined by combinations of sensor values) and hardware profiles, which are to be used within the contexts. For instance, hardware profile definition unit 735 may access the definitions to identify the combination of platform components and functionality that should be enabled based on the conditions sensed by the sensors 742-745 and the type of workload and service level objective(s) (SLO) for the workloads to be run in a deployment using the platform device 705. In one example, a hardware profile rule or trigger may be defined and include a range of sensor metrics associated with the hardware profile's use, the type of workload impacted, and the platform components to be active in the hardware profile. For instance, as an illustrative example, where the workload involves video analytics, it may be determined that when the platform operates with a particular temperature range (e.g., between 40 and 50 degrees Celsius), additional hardware (e.g., 720), such as an integrated graphics processing unit (GPU) and/or video processing unit (VPU) on the platform, should be activated at the platform to expose this hardware to the application software for use in accelerating and/or smoothing performance of the workload (over relying only on a CPU or other general purpose processing hardware), among other examples.

In some implementations, the hardware profile definition unit 735 can use telemetry and other information to initiate an activation/deactivation of various components of the platform. For instance, platform and service monitoring block 740 may monitor current performance of each of the workloads of the platform and determine whether SLOs or other performance policies or thresholds are being achieved. If the SLOs are being met, the platform may determine that no modification should be made to the platform components exposed to the workloads. If performance is found lacking, the platform monitoring block 740 may trigger the use of the hardware profile definition unit 735 to determine whether any sensor (e.g., 742-745) has generated data that that indicates that a change to the hardware profile of the platform device may be worthwhile. In some cases, no alternative hardware profile may be available to address the shortfall in performance and the operating system or orchestrator may be notified of the same (e.g., using a software interrupt or other mechanism). In other instances, an alternative or enhanced hardware profile may be identified and the hardware profile definition unit 735 may activate the combination of features associated with the alternative hardware profile for providing improved service performance for this particular workload. The hardware profile definition block 735 may also notify the service or orchestrator that the new feature or component has been made available for the workload. The service, orchestrator, and/or operating system used for the service may recognize the new features and enable use of the newly exposed features by software.

A metering block 730 may be engaged to log details pertaining to the dynamic reconfiguring of the hardware profile. For instance, the metering block 730 may capture and log the current contextual data (e.g., used by the hardware profile definition block 735) including information describing the workload and any associated SLA and telemetry information, log details of the previous (e.g., substandard) performance that the service was achieving using the previous hardware profile, among other example information. Once a reconfiguration of the hardware profile has been performed (e.g., by activating and exposing corresponding functionality of the platform), the metering block 730 may continue to monitor and log activity involving the activated hardware profile until it is determined that the platform should revert to the previous (e.g., base or standard) hardware profile, or until a different, enhanced hardware profile is activated. For instance, the metering block 730 may feedback information to the hardware profile definition block 735 to identify to the hardware profiling definition block the resulting context and allow the hardware profile definition block 735 to determine whether the activated hardware profile is performing as expected. The metering block 730 may also generate information for determining fees to be charged in association with the temporary enablement of features activated in the hardware profile. For instance, a customer may license the use of the platform device 705. In some implementations, a base level of functionality may be defined under the license, under which the user may have unlimited use in their applications. Other functionality or components, which may only be activated temporarily in certain contexts, may be subject to additional charges under the license in this example. Indeed, a variety of different licensing, fees, and business models may be developed, which may take advantage of a platform device's capability to dynamically turn on higher value or specialty hardware or functionality, and the metering block 730 may be used to help log, account for, audit, and otherwise implement such licenses or services by tracking and logging the nature and duration (and successful) use of various hardware profiles.

A hardware profile predictor block 725 may also be included in a platform device 705 and may be responsive for estimating or predicting a future potential demand for a particular hardware profile, which may be dynamically implemented by activating/deactivating various components (e.g., 715, 720, 722, etc.) of the platform device 705. For instance, the hardware profile predictor block may take as inputs, data generated by sensors (e.g., 742-745), as well as data generated by the platform monitoring block 740 to progressively monitor the performance of various services or applications being run using the platform device's resources, as well as the operating context, which may change over time. Based on detected trends or metrics in the operating context and one or more applications' performance, the hardware profile predictor block 725 may determine a potential opportunity to activate one or more resources to alleviate a negative trend in performance or a trend indicating that resources of the platform have been over-allocated to an application, among other examples. Prediction algorithms implemented in the hardware profile predictor block 725 may run, for instance, in small compute or acceleration blocks on the platform device. Prediction algorithm may vary based on the deployment model (e.g., industrial, vehicles (e.g., V2X), etc.). Results of the hardware profile predictor block 725 may be used to change, update, or improve the rules and hardware profile definitions used by the hardware profile definition block 735, among other example uses. For instance, the results of the hardware profile predictor block 735 may be used as a basis for modifying the knobs and rules that are used to define hardware profiles and may be used to modify and update sensor ID and metadata information, among other features.

In some implementations, one or more machine learning models may be employed by or in cooperation with the hardware profile predictor block 725 to also consider the historical use of dynamic changes to the hardware profile and the effect such changes had on performance of various types of applications. In some cases, the logic or models replied upon by the hardware profile predictor block 725 may be continuously improved by allowing the model to “learn” through continuous training using performance data (e.g., from the platform monitoring block 740), historical data recording the use and success of changes to the hardware profile (e.g., using the metering block 730). In some implementations, the hardware profile predictor block 725 may iteratively cause resources to be activated, for instance, in a random manner, to experimentally observe whether and how the activation of such resources impact various types of workloads, to further tune its prediction logic, among other example features.

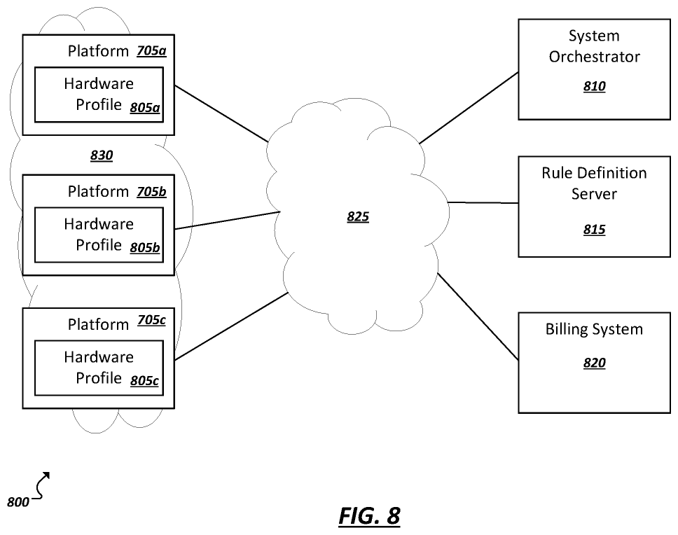

Turning to FIG. 8, a simplified block diagram 800 is shown of an example system, such as an edge deployment including platform devices to implement a service, application, or other workload. In this example, each of the platform devices (e.g., 705a-c) may each be equipped with logic to dynamically change their respective hardware profiles (e.g., 805a-c) based on telemetry and workload data detected at the corresponding platform device. The platform devices may include some platform devices with the same set of components and functionality, as well as a mix of platform devices, with some having other components and functionality than others, which may enable different hardware profile options between platform devices.

Other systems may be provided to assist such a deployment. For instance, interfaces of a platform device (e.g., 705a-c) may interface with a network 825 to communicate with supporting backend systems. For instance, a system orchestrator 810 may be provided to orchestrate one or multiple different application and services within a distributed computing environment, such as an edge deployment 830. The system orchestrator 810, in some implementations, may be implemented on one of the platforms of the edge deployment. The system orchestrator 810 may include logic to identify dynamic changes to hardware profiles 805a-c and identify when new components or functionality of the platform devices are exposed and seamlessly leverage these components to execute or implement services within the edge deployment 830.

Generally, software applications, services, and microservices, which are run on the platform devices (e.g., 705a-c) will be adapted and updated to react to new features exposed by a dynamic change to a platform device's hardware definition (e.g., 805a-c). The software stack may also interface with and provide information to the logic of the platform device used to trigger dynamic hardware definition changes. For instance, the software stack may provide application type information, service level policy information (e.g., SLA information, SLO information, etc.), QoS policy information, among other information to the hardware profile definition block of the platform device (e.g., via an operating system API or other interface). Further, the software stack may provide or expose performance metrics and other information to the platform device for performance monitoring. Further, the software stack may include logic to discover when new functionality or components have been exposed through a hardware profile change, for instance, through orchestrator operator and plugins, new libraries or APIs, new microservices, new interrupts, among other example features.

As another example, external server systems may be provided, such as a rule definition server 815, to enable the definition of hardware profiles and conditions for launching various hardware profiles on platform devices. For instance, hardware profile definition blocks on the platform devices 705a-c may reference rules or conditions populated in registers or other data structures to identify a set of conditions (e.g., a combination of telemetry/sensor values falling within a range or beyond a threshold, a type of workflow, a QoS or SLA associated with the workflow, etc.) for which a dynamic change to the hardware profile should be carried out at the platform device (e.g., by activating/deactivating certain hardware at the platform device). In some implementations, rules and conditions and even hardware profile definitions may be developed and provided to (e.g., written to) the platform devices 705a-c by an example rule definition server 815. In some implementations, a rule definition server 815 may also receive data from the platform devices 705a-c, for instance, as generated by metering blocks or hardware profile predictor blocks on the platform devices, to improve the development of hardware profile definitions and conditions offered for use to platform devices 705a-c. For instance, a rule definition server 815 may use feedback from multiple different platform devices (e.g., 705a-c) to develop (e.g., using machine learning models trained on this feedback) hardware profile rules for use by the hardware profile definition blocks of the platform devices (e.g., 705a-c), among other examples.

As noted above, the dynamic activation and deactivation of components functionality at various platform devices (e.g., 705a-c) may enable new, more granular, pricing and licensing models, which customers may take advantage of to pay for only those capabilities that they use and derive value from (e.g., based on a platform device detecting that activating a particular IP block will improve functioning of an application within a given context). A billing system server may receive log data from platform devices (e.g., from respective metering blocks) to identify usage of components and functionality for which an additional or elevated fee may be associated. In some instances, billing and metering data may be accessed by the billing system 820 through out-of-band communications (e.g., with authentication), or in-band with proper credentials, among other examples.

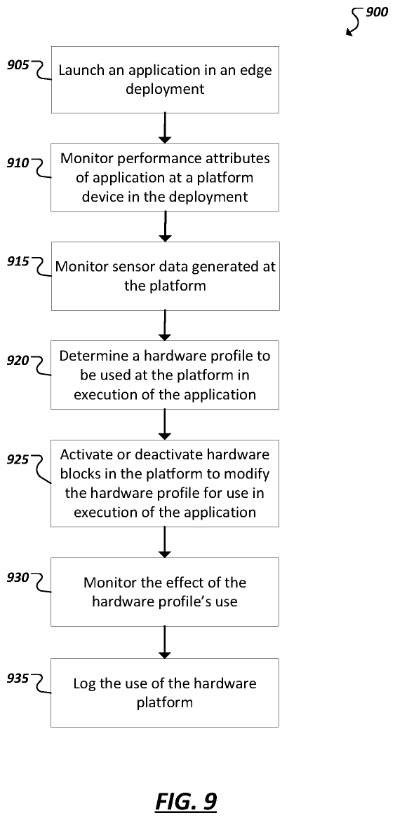

Turning to FIG. 9, a simplified flow diagram 900 is shown illustrating an example technique for dynamically modifying a hardware profile of a platform device, such as an edge device for deployment within an edge computing system. An application may be launched 905 in the deployment and the platform device may be used (potentially with other devices in the deployment) to execute at least a portion of the application and implement a particular use case. Performance of the application's execution may be monitored 910, with information describing a SLA or other performance level being considered together with current performance data indicating the current attributes associated with the performance level of the application. Sensor may be present on the platform device and may sense physical characteristics of an environment in which the platform device is deployed. Sensors may sense physical characteristics such as temperature, humidity, vibration, electromagnetic interference, and other characteristics and the platform device may monitor 915 attributes within its environment, which have the potential of impacting the platform device's performance when executing the application. In some implementations, internal sensors of the platform device may be supplemented with sensor data from other sensor devices (e.g., external to the platform device), among other examples.

When an application is launched and an orchestrator or other logic used to assign some processing or other execution functions to the platform device, a first hardware profile may be used by the platform device, the hardware profile defined by the activate hardware blocks and functions that are made available for use in the execution of the application. Monitoring the performance of the application and the sensor data may reveal changes reflecting some deficiencies in the current hardware used to execute the application. Indeed, hardware profile modification logic (e.g., implemented in hardware and/or firmware on the platform device) may be used (e.g., the hardware profile definition block, platform monitoring block, metering block, hardware profile prediction block, etc.) to determine 920 that an alternate hardware profile of the platform device may be used to better meet the service level objectives for the application. For instance, the platform device may possess circuitry to selectively activate and deactivate (or lock or block software access to) certain hardware blocks and functionality within the platform device. Based on the identified attributes of the application's execution and/or physical conditions impacting the platform device, the platform device may autonomously and dynamically modify or switch its hardware profile by activating (and/or deactivating) 925 a different combination of hardware features. With the alternative hardware profile activated, the application may continue to execute and automatically divert at least portions of workloads to newly activated hardware blocks of the platform device. The use of the activate hardware block(s) may be monitored, as well as the effect of the new hardware profile's use in the execution of the application. The use of certain activated hardware blocks in the alternate hardware profile or the alternate hardware profile itself, may be logged 935 securely directly at the platform device. In some cases, this log data may be shared with other components of the platform device or external computing devices, for instance, to assist in improving predictions and rules for launching various alternative hardware profiles at the platform device, applying a use-based billing structure to the use of the platform device in its use within the deployment, among other example uses.

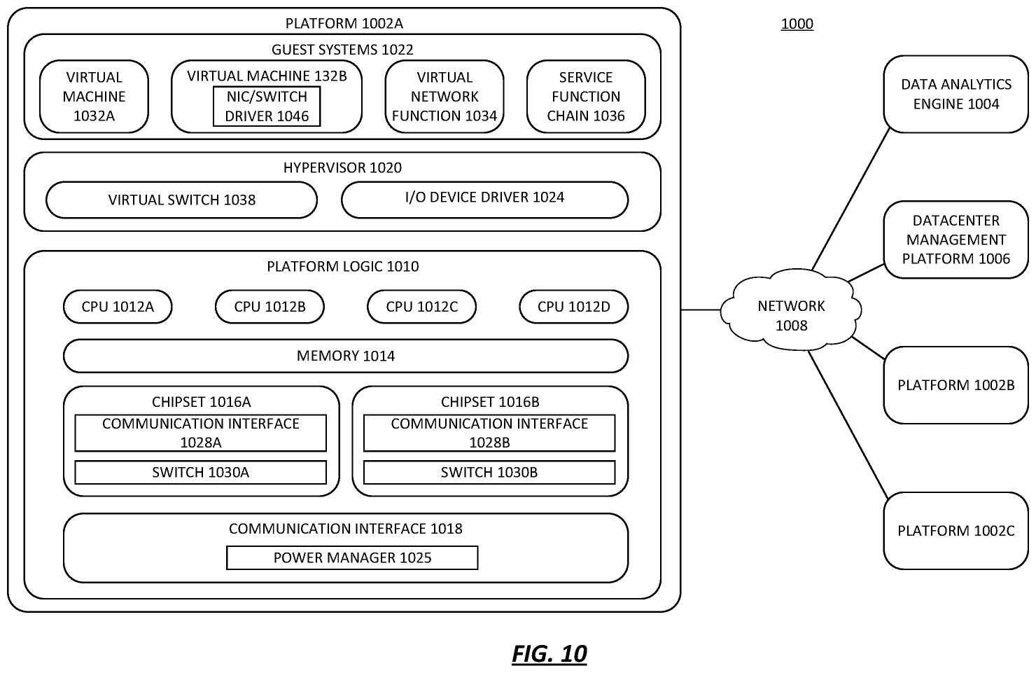

Note that the apparatus', methods', and systems described above may be implemented in any electronic device or system as aforementioned. FIG. 10 illustrates a block diagram of components of a datacenter or deployment 1000 in accordance with certain embodiments. In the embodiment depicted, deployment 1000 includes a plurality of platforms 1002, data analytics engine 1004, and datacenter management platform 1006 coupled together through network 1008. A platform 1002 may include platform logic 1010 with one or more central processing units (CPUs) 1012, memories 1014 (which may include any number of different modules), chipsets 1016, communication interfaces 1018, and any other suitable hardware and/or software to execute a hypervisor 1020 or other operating system capable of executing processes associated with applications running on platform 1002. In some examples, a platform 1002 may function as a host platform for one or more guest systems 1022 that invoke these applications. The platform may be logically or physically subdivided into clusters and these clusters may be enhanced through specialized networking accelerators and the use of Compute Express Link (CXL) memory semantics to make such cluster more efficient, among other example enhancements.

Each platform 1002 may include platform logic 1010. Platform logic 1010 comprises, among other logic enabling the functionality of platform 1002, one or more CPUs 1012, memory 1014, one or more chipsets 1016, and communication interface 1018. Although three platforms are illustrated, deployment 1000 may include any suitable number of platforms. In various examples, a platform 1002 may reside on a circuit board that is installed in a chassis, rack, compossible servers, disaggregated servers, or other suitable structures that comprises multiple platforms coupled together through network 1008 (which may comprise, e.g., a rack or backplane switch).

CPUs 1012 may each comprise any suitable number of processor cores. The cores may be coupled to each other, to memory 1014, to at least one chipset 1016, and/or to communication interface 1018, through one or more controllers residing on CPU 1012 and/or chipset 1016. In particular examples, a CPU 1012 is embodied within a socket that is permanently or removeably coupled to platform 1002. Although four CPUs are shown, a platform 1002 may include any suitable number of CPUs. In some implementations, application to be executed using the CPU (or other processors) may include physical layer management applications, which may enable customized software-based configuration of the physical layer of one or more interconnect used to couple the CPU (or related processor devices) to one or more other devices in a data center system.

Memory 1014 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 1014 may be used for short, medium, and/or long-term storage by platform 1002. Memory 1014 may store any suitable data or information utilized by platform logic 1010, including software embedded in a computer readable medium, and/or encoded logic incorporated in hardware or otherwise stored (e.g., firmware). Memory 1014 may store data that is used by cores of CPUs 1012. In some examples, memory 1014 may also comprise storage for instructions that may be executed by the cores of CPUs 1012 or other processing elements (e.g., logic resident on chipsets 1016) to provide functionality associated with components of platform logic 1010. Additionally or alternatively, chipsets 1016 may each comprise memory that may have any of the characteristics described herein with respect to memory 1014. Memory 1014 may also store the results and/or intermediate results of the various calculations and determinations performed by CPUs 1012 or processing elements on chipsets 1016. In various examples, memory 1014 may comprise one or more modules of system memory coupled to the CPUs through memory controllers (which may be external to or integrated with CPUs 1012). In various examples, one or more particular modules of memory 1014 may be dedicated to a particular CPU 1012 or other processing device or may be shared across multiple CPUs 1012 or other processing devices.

A platform 1002 may also include one or more chipsets 1016 comprising any suitable logic to support the operation of the CPUs 1012. In various examples, chipset 1016 may reside on the same package as a CPU 1012 or on one or more different packages. Each chipset may support any suitable number of CPUs 1012. A chipset 1016 may also include one or more controllers to couple other components of platform logic 1010 (e.g., communication interface 1018 or memory 1014) to one or more CPUs. Additionally or alternatively, the CPUs 1012 may include integrated controllers. For example, communication interface 1018 could be coupled directly to CPUs 1012 via integrated I/O controllers resident on each CPU.

Chipsets 1016 may each include one or more communication interfaces 1028. Communication interface 1028 may be used for the communication of signaling and/or data between chipset 1016 and one or more I/O devices, one or more networks 1008, and/or one or more devices coupled to network 1008 (e.g., datacenter management platform 1006 or data analytics engine 1004). For example, communication interface 1028 may be used to send and receive network traffic such as data packets. In a particular example, communication interface 1028 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 1016 (e.g., switch 1030) and another device coupled to network 1008. In some examples, network 1008 may comprise a switch with bridging and/or routing functions that is external to the platform 1002 and operable to couple various I/O controllers (e.g., NICs) distributed throughout the deployment 1000 (e.g., on different platforms) to each other. In various examples an I/O controller may be integrated with the chipset (i.e., may be on the same integrated circuit or circuit board as the rest of the chipset logic) or may be on a different integrated circuit or circuit board that is electromechanically coupled to the chipset. In some examples, communication interface 1028 may also allow I/O devices integrated with or external to the platform (e.g., disk drives, other NICs, etc.) to communicate with the CPU cores.

Switch 1030 may couple to various ports (e.g., provided by NICs) of communication interface 1028 and may switch data between these ports and various components of chipset 1016 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 1030 may be a physical or virtual (i.e., software) switch.

Platform logic 1010 may include an additional communication interface 1018. Similar to communication interface 1028, communication interface 1018 may be used for the communication of signaling and/or data between platform logic 1010 and one or more networks 1008 and one or more devices coupled to the network 1008. For example, communication interface 1018 may be used to send and receive network traffic such as data packets. In a particular example, communication interface 1018 comprises one or more physical I/O controllers (e.g., NICs). These NICs may enable communication between any suitable element of platform logic 1010 (e.g., CPUs 1012) and another device coupled to network 1008 (e.g., elements of other platforms or remote nodes coupled to network 1008 through one or more networks). In particular examples, communication interface 1018 may allow devices external to the platform (e.g., disk drives, other NICs, etc.) to communicate with the CPU cores. In various examples, NICs of communication interface 1018 may be coupled to the CPUs through I/O controllers (which may be external to or integrated with CPUs 1012). Further, as discussed herein, I/O controllers may include a power manager 1025 to implement power consumption management functionality at the I/O controller (e.g., by automatically implementing power savings at one or more interfaces of the communication interface 1018 (e.g., a PCIe interface coupling a NIC to another element of the system), among other example features.

Platform logic 1010 may receive and perform any suitable types of processing requests. A processing request may include any request to utilize one or more resources of platform logic 1010, such as one or more cores or associated logic. For example, a processing request may comprise a processor core interrupt; a request to instantiate a software component, such as an I/O device driver 1024 or virtual machine 1032; a request to process a network packet received from a virtual machine 1032 or device external to platform 1002 (such as a network node coupled to network 1008); a request to execute a workload (e.g., process or thread) associated with a virtual machine 1032, application running on platform 1002, hypervisor 1020 or other operating system running on platform 1002; or other suitable request.

In various examples, processing requests may be associated with guest systems 1022. A guest system may comprise a single virtual machine (e.g., virtual machine 1032a or 1032b) or multiple virtual machines operating together (e.g., a virtual network function (VNF) 1034 or a service function chain (SFC) 1036). As depicted, various examples may include a variety of types of guest systems 1022 present on the same platform 1002.

A virtual machine 1032 may emulate a computer system with its own dedicated hardware. A virtual machine 1032 may run a guest operating system on top of the hypervisor 1020. The components of platform logic 1010 (e.g., CPUs 1012, memory 1014, chipset 1016, and communication interface 1018) may be virtualized such that it appears to the guest operating system that the virtual machine 1032 has its own dedicated components.

A virtual machine 1032 may include a virtualized NIC (vNIC), which is used by the virtual machine as its network interface. A vNIC may be assigned a media access control (MAC) address, thus allowing multiple virtual machines 1032 to be individually addressable in a network.

In some examples, a virtual machine 1032b may be paravirtualized. For example, the virtual machine 1032b may include augmented drivers (e.g., drivers that provide higher performance or have higher bandwidth interfaces to underlying resources or capabilities provided by the hypervisor 1020). For example, an augmented driver may have a faster interface to underlying virtual switch 1038 for higher network performance as compared to default drivers.

VNF 1034 may comprise a software implementation of a functional building block with defined interfaces and behavior that can be deployed in a virtualized infrastructure. In particular examples, a VNF 1034 may include one or more virtual machines 1032 that collectively provide specific functionalities (e.g., wide area network (WAN) optimization, virtual private network (VPN) termination, firewall operations, load-balancing operations, security functions, etc.). A VNF 1034 running on platform logic 1010 may provide the same functionality as traditional network components implemented through dedicated hardware. For example, a VNF 1034 may include components to perform any suitable NFV workloads, such as virtualized Evolved Packet Core (vEPC) components, Mobility Management Entities, 3rd Generation Partnership Project (3GPP) control and data plane components, etc.

SFC 1036 is group of VNFs 1034 organized as a chain to perform a series of operations, such as network packet processing operations. Service function chaining may provide the ability to define an ordered list of network services (e.g., firewalls, load balancers) that are stitched together in the network to create a service chain.

A hypervisor 1020 (also known as a virtual machine monitor) may comprise logic to create and run guest systems 1022. The hypervisor 1020 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 1010. Services of hypervisor 1020 may be provided by virtualizing in software or through hardware assisted resources, or both. Multiple instances of a variety of guest operating systems may be managed by the hypervisor 1020. Each platform 1002 may have a separate instantiation of a hypervisor 1020.

Hypervisor 1020 may be a native or bare-metal hypervisor that runs directly on platform logic 1010 to control the platform logic and manage the guest operating systems. Alternatively, hypervisor 1020 may be a hosted hypervisor that runs on a host operating system and abstracts the guest operating systems from the host operating system. Various examples may include one or more non-virtualized platforms 1002, in which case any suitable characteristics or functions of hypervisor 1020 described herein may apply to an operating system of the non-virtualized platform.

Hypervisor 1020 may include a virtual switch 1038 that may provide virtual switching and/or routing functions to virtual machines of guest systems 1022. The virtual switch 1038 may comprise a logical switching fabric that couples the vNICs of the virtual machines 1032 to each other, thus creating a virtual network through which virtual machines may communicate with each other. Virtual switch 1038 may also be coupled to one or more networks (e.g., network 1008) via physical NICs of communication interface 1018 so as to allow communication between virtual machines 1032 and one or more network nodes external to platform 1002 (e.g., a virtual machine running on a different platform 1002 or a node that is coupled to platform 1002 through the Internet or other network). Virtual switch 1038 may comprise a software element that is executed using components of platform logic 1010. In various examples, hypervisor 1020 may be in communication with any suitable entity (e.g., a SDN controller) which may cause hypervisor 1020 to reconfigure the parameters of virtual switch 1038 in response to changing conditions in platform 1002 (e.g., the addition or deletion of virtual machines 1032 or identification of optimizations that may be made to enhance performance of the platform).

Hypervisor 1020 may include any suitable number of I/O device drivers 1024. I/O device driver 1024 represents one or more software components that allow the hypervisor 1020 to communicate with a physical I/O device. In various examples, the underlying physical I/O device may be coupled to any of CPUs 1012 and may send data to CPUs 1012 and receive data from CPUs 1012. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 1012. In one example, the underlying I/O device is a physical NIC or physical switch. For example, in one example, the underlying I/O device of I/O device driver 1024 is a NIC of communication interface 1018 having multiple ports (e.g., Ethernet ports).

In other examples, underlying I/O devices may include any suitable device capable of transferring data to and receiving data from CPUs 1012, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various examples, when a processing request is received, the I/O device driver 1024 or the underlying I/O device may send an interrupt (such as a message signaled interrupt) to any of the cores of the platform logic 1010. For example, the I/O device driver 1024 may send an interrupt to a core that is selected to perform an operation (e.g., on behalf of a virtual machine 1032 or a process of an application). Before the interrupt is delivered to the core, incoming data (e.g., network packets) destined for the core might be cached at the underlying I/O device and/or an I/O block associated with the CPU 1012 of the core. In some examples, the I/O device driver 1024 may configure the underlying I/O device with instructions regarding where to send interrupts.

In some examples, as workloads are distributed among the cores, the hypervisor 1020 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 1032 can be balanced across cores using network load and traffic patterns rather than just CPU and memory utilization metrics.

The elements of platform logic 1010 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 1000 may be coupled together in any suitable, manner such as through one or more networks 1008. A network 1008 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various examples, guest systems 1022 may communicate with nodes that are external to the deployment 1000 through network 1008.

“Logic” (e.g., as found in I/O controllers, power managers, latency managers, etc. and other references to logic in this application) may refer to hardware, firmware, software and/or combinations of each to perform one or more functions. In various examples, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some examples, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of examples of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one example, refers to the hardware, which is specifically configured to recognize and/or execute the code to be held on a non-transitory medium. Furthermore, in another example, use of a module refers to the non-transitory medium including the code, which is specifically adapted to be executed by the microcontroller to perform predetermined operations. And as can be inferred, in yet another example, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one example, use of the term logic includes hardware, such as transistors, registers, or other hardware, such as programmable logic devices.

Use of the phrase ‘to’ or ‘configured to,’ in one example, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one example, refers to some apparatus, logic, hardware, and/or element designed in such a way to enable use of the apparatus, logic, hardware, and/or element in a specified manner. Note as above that use of to, capable to, or operable to, in one example, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one example, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one example, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a host processor to execute at least a portion of an application; a set of hardware blocks, where each hardware block in the set of hardware blocks includes hardware logic to implement respective functionality and is configured to be selectively activated and deactivated at the direction of the host processor for use in execution of at least the portion of the application; a set of sensors to sense environmental conditions for the apparatus; a performance monitoring block including circuitry to identify performance attributes of the application; and a hardware profile definition block including circuitry to: determine, from the environmental conditions and the performance attributes of the application, a hardware profile for use by the application, where the hardware profile includes a particular one of the set of hardware blocks, and execution of the application begins without use of the particular hardware block; and cause the particular hardware block to be activated and used during the execution of the application.

Example 2 includes the subject matter of example 1, where the particular hardware block is to be activated based on a change in at least one of the environmental conditions as measured by the set of sensors or the performance attributes of the application.

Example 3 includes the subject matter of example 2, where the hardware profile definition block is further to predict a need for the particular hardware block in execution of the application based on the change.

Example 4 includes the subject matter of example 2, where the hardware profile definition block is further to: identify another change in in at least one of the environmental conditions as measured by the set of sensors or the performance attributes of the application; and deactivate the particular hardware block based on the other change, where execution of the application is to continue without use of the particular hardware block after deactivation of the particular hardware block.

Example 5 includes the subject matter of any one of examples 1-4, where the set of sensors includes a temperature sensor and the environmental conditions include a local ambient temperature.

Example 6 includes the subject matter of any one of examples 1-5, where the set of sensors includes a geolocation sensor and the environmental conditions include a location of the apparatus.

Example 7 includes the subject matter of any one of examples 1-6, where the particular hardware block includes a hardware accelerator block.

Example 8 includes the subject matter of any one of examples 1-7, where the particular hardware block includes a processor core, the host processor includes a plurality of processor cores, and the application begins execution when at least a portion of the plurality of processor cores are deactivated.

Example 9 includes the subject matter of any one of examples 1-8, including an edge computing device.

Example 10 includes the subject matter of any one of examples 1-9, further including metering circuitry to log activation of the hardware profile and duration of the activation of the particular hardware.

Example 11 includes the subject matter of example 10, where use of the particular hardware block is to be billed at a different rate than use of one or more other hardware blocks in the hardware profile, and the apparatus is further to send log data to an external computing system for use in billing a customer for use of the particular hardware block.

Example 12 is a non-transitory machine-readable storage medium with instructions stored thereon, the instructions executable to cause the machine to: begin execution of an application on a deployment including a particular platform, where the platform includes a plurality of hardware components, and a subset of the plurality of hardware components are deactivated when execution of the application begins; identify that a particular subset of the plurality of hardware components is activated by the particular platform, where the particular hardware component is activated based on telemetry information collected for the particular platform; and adjust execution of the application to use the particular hardware component based on activation of the particular hardware component, where use of the particular hardware component assists in the execution of the application meeting a particular service level.

Example 13 includes the subject matter of example 12, where the instructions are executable to further cause the machine to orchestrate execution of the application on the deployment.

Example 14 includes the subject matter of example 13, where the deployment includes an edge deployment, and the particular platform is one of a plurality of platforms in the deployment.

Example 15 includes the subject matter of any one of examples 12-14, where the instructions are executable to further cause the machine to: determine performance metrics for execution of the particular application; and send the performance metrics to the particular platform, where the particular hardware component is activated based on the performance metrics.

Example 16 includes the subject matter of any one of examples 12-15, where the instructions are executable to further cause the machine to: identify that the particular subset of hardware components is deactivated by the particular platform; and further adjust execution of the application to continue execution of the application without use of the particular subset of hardware components.

Example 17 is a method including: beginning execution of an application on a deployment including a particular platform, where the platform includes a plurality of hardware components, and a subset of the plurality of hardware components are deactivated when execution of the application begins; identifying that a particular subset of the plurality of hardware components is activated by the particular platform, where the particular hardware component is activated based on telemetry information collected for the particular platform; and adjusting execution of the application to use the particular hardware component based on activation of the particular hardware component, where use of the particular hardware component assists in the execution of the application meeting a particular service level.

Example 18 includes the subject matter of example 17, further including causing the machine to orchestrate execution of the application on the deployment.

Example 19 includes the subject matter of example 18, where the deployment includes an edge deployment, and the particular platform is one of a plurality of platforms in the deployment.

Example 20 includes the subject matter of any one of examples 17-19, further including: determining performance metrics for execution of the particular application; and sending the performance metrics to the particular platform, where the particular hardware component is activated based on the performance metrics.

Example 21 includes the subject matter of any one of examples 17-20, further including: identifying that the particular subset of hardware components is deactivated by the particular platform; and further adjusting execution of the application to continue execution of the application without use of the particular subset of hardware components.

Example 22 is a system including means to perform the method of any one of examples 17-21.

Example 23 is a system including: a platform device including: a plurality of hardware blocks, where each hardware block in the plurality of hardware blocks is to provide respective functionality for use in execution of an application, where a subset of the plurality of hardware blocks are deactivated and unavailable for use in the execution of the application at a start of the execution of the application; a set of sensors; a hardware profile modification circuitry to: identify performance characteristics of the execution of the application; receive telemetry data generated by the set of sensors, where the telemetry data describes physical characteristics of an environment in which the platform device is deployed; and dynamically activate at least a particular one of the subset of hardware blocks based on the performance characteristics and the physical characteristics, where following activation of the particular hardware block, the execution of the application continues and uses the particular hardware block.

Example 24 includes the subject matter of example 23, where the platform device further includes logging circuitry to: identify an effect on performance characteristics of the execution of the application following activation of the particular hardware block; and log the activation of the particular hardware block and the effect on the performance characteristics.

Example 25 includes the subject matter of example 24, further including a billing server system to: receive log data over a network from the platform device, where the log data describes the activation of the particular hardware block; and determine fees to charge a customer associated with the platform device based on the log data.

Example 26 includes the subject matter of any one of examples 23-25, further including an orchestration system to: orchestrate execution of the application within a computing environment, where the computing environment includes the platform device; identify the activation of the particular hardware block; and adjust execution of the application to use the particular hardware block.

Example 27 includes the subject matter of example 26, where the computing environment includes an edge deployment including a plurality of platform devices.

Example 28 includes the subject matter of example 27, further including a second platform device included in the plurality of platform devices, where the second platform device includes hardware profile modification circuitry, and a different set of hardware blocks, and the hardware profile modification circuitry of the second platform device is to selectively activate or deactivate at least a subset of the different set of hardware blocks during execution of the application.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a host processor to execute;
a set of hardware blocks, wherein each hardware block in the set of hardware blocks comprises hardware logic to implement respective functionality and is configured to be selectively activated and deactivated at direction of the host processor; and
a hardware profile definition circuitry to:
identify environmental conditions of the apparatus based on data from a set of sensors;
determine, from the environmental conditions, a hardware profile for activation, wherein the hardware profile comprises a particular one of the set of hardware blocks, and execution of the application begins without use of the particular hardware block; and
cause the particular hardware block to be activated and used during the execution of the application.

2. The apparatus of claim 1, wherein the host processor is to execute at least a portion of an application and the apparatus further comprises a performance monitoring block comprising circuitry to identify performance attributes of the application, wherein the hardware profile is determined based on the environmental conditions and the performance attributes.

3. The apparatus of claim 2, wherein the particular hardware block is to be activated based on a change in at least one of the environmental conditions as measured by the set of sensors or the performance attributes of the application.

4. The apparatus of claim 3, wherein the hardware profile definition block is further to predict a need for the particular hardware block in execution of the application based on the change.

5. The apparatus of claim 3, wherein the hardware profile definition block is further to:
identify another change in in at least one of the environmental conditions as measured by the set of sensors or the performance attributes of the application; and
deactivate the particular hardware block based on the other change, wherein execution of the application is to continue without use of the particular hardware block after deactivation of the particular hardware block.

6. The apparatus of claim 1, further comprising the set of sensors.

7. The apparatus of claim 6, wherein the set of sensors comprises a temperature sensor and the environmental conditions comprise a local ambient temperature.

8. The apparatus of claim 1, wherein the particular hardware block comprises a hardware accelerator block.

9. The apparatus of claim 1, wherein the particular hardware block comprises a processor core, the host processor comprises a plurality of processor cores, and the application begins execution when at least a portion of the plurality of processor cores are deactivated.

10. The apparatus of claim 1, comprising an edge computing device.

11. The apparatus of claim 1, further comprising metering circuitry to log activation of the hardware profile and duration of the activation of the particular hardware block.

12. The apparatus of claim 11, wherein use of the particular hardware block is to be billed at a different rate than use of one or more other hardware blocks in the hardware profile, and the apparatus is further to send log data to an external computing system for use in billing a customer for use of the particular hardware block.

13. At least one non-transitory machine-readable storage medium with instructions stored thereon, the instructions executable to cause the machine to:
begin execution of an application on a deployment comprising a particular platform, wherein the platform comprises a plurality of hardware components, and a subset of the plurality of hardware components are deactivated when execution of the application begins;
identify that a particular subset of the plurality of hardware components is activated by the particular platform, wherein the particular hardware component is activated based on telemetry information collected for the particular platform; and
adjust execution of the application to use the particular hardware component based on activation of the particular hardware component, wherein use of the particular hardware component assists in the execution of the application meeting a particular service level.

14. The storage medium of claim 13, wherein the instructions are executable to further cause the machine to orchestrate execution of the application on the deployment, the deployment comprises an edge deployment, and the particular platform is one of a plurality of platforms in the deployment.

15. The storage medium of claim 13, wherein the instructions are executable to further cause the machine to:
determine performance metrics for execution of the application; and
send the performance metrics to the particular platform, wherein the particular hardware component is activated based on the performance metrics.

16. The storage medium of claim 13, wherein the instructions are executable to further cause the machine to:
identify that the particular subset of hardware components is deactivated by the particular platform; and
further adjust execution of the application to continue execution of the application without use of the particular subset of hardware components.

17. A system comprising:
a platform device comprising:
a plurality of hardware blocks, wherein each hardware block in the plurality of hardware blocks is to provide respective functionality for use in execution of an application, wherein a subset of the plurality of hardware blocks are deactivated and unavailable for use in the execution of the application at a start of the execution of the application;
a set of sensors;
a hardware profile modification circuitry to:
identify performance characteristics of the execution of the application;
receive telemetry data generated by the set of sensors, wherein the telemetry data describes physical characteristics of an environment in which the platform device is deployed; and
dynamically activate at least a particular one of the subset of hardware blocks based on the performance characteristics and the physical characteristics, wherein following activation of the particular hardware block, the execution of the application continues and uses the particular hardware block.

18. The system of claim 17, wherein the platform device further comprises logging circuitry to:
identify an effect on performance characteristics of the execution of the application following activation of the particular hardware block; and
log the activation of the particular hardware block and the effect on the performance characteristics.

19. The system of claim 18, further comprising a billing server system to:
receive log data over a network from the platform device, wherein the log data describes the activation of the particular hardware block; and
determine fees to charge a customer associated with the platform device based on the log data.

20. The system of claim 17, further comprising a second platform device, wherein the second platform device comprises hardware profile modification circuitry and a different set of hardware blocks, and the hardware profile modification circuitry of the second platform device is to selectively activate or deactivate at least a subset of the different set of hardware blocks during execution of the application.
